(19) United States
(12) Patent Application Publication
(10) Pub. No.: US 2012/0024697 A1
(43) Pub. Date: Feb. 2, 2012

(54) Membranes

(75) Inventors: Harro Antheunis, Tilburg (NL); Dana Manuela Sterescu, Tilburg (NL)

(73) Assignee: Fujifilm Manufacturing Europe B.V., Tilburg (NL)

(21) Appl. No.: 13/256,967

(22) PCT Filed: Mar. 16, 2010
(86) PCT No.: PCT/GB2010/050446

§ 371 Date: Oct. 18, 2011

(30) Foreign Application Priority Data
Mar. 17, 2009 (GB) 0904558.4

(51) Int. Cl. C25B 13/04; C08F 2/50; C25B 9/08; C08F 2/48

(52) U.S. Cl. 204/252; 427/508; 204/295

(57) ABSTRACT

Process for manufacturing a composite membrane comprising a porous support and a polymeric separation layer having acidic or basic groups comprising the steps of: (i) applying a composition to a porous support; and (ii) curing the composition to form the polymeric separation layer thereon; wherein the composition comprises the components (a) a compound having one ethylenically unsaturated group; and (b) a crosslinking agent having an acrylamide group; and wherein the curing is achieved by irradiating the composition for less than 30 seconds. The membranes are useful in reverse electrodialysis e.g. for generating blue energy and have good resistance to deterioration, even under hot and high pH conditions.

This invention relates to membranes, to a process for their preparation and to the use of such membranes, e.g. in reverse electrodialysis.

Global warming and high fossil fuel prices have accelerated interest in renewable energy sources. The most common sources of renewable energy are wind power and solar power. Harvesting wind power using turbines is increasingly common, although many regard the turbines as unsightly and they are ineffective in low wind and on very windy days. Solar power is also weather-dependent and not particularly efficient in countries far from the hemisphere.

The principle of using reverse electrodialysis (RED) to generate power from seawater and fresh water was described for the first time in 1954 by R. Plattle in Nature. Experimental results were obtained in America and Israel in the seventies. U.S. Pat. No. 4,171,409 is an early example of innovation in this field. KEMA in the Netherlands revived the investigation into RED in 2002 under the name “blue energy”, winning the Dutch Innovation Award for 2004 in the category “Energy and Environment”. In the Netherlands there is a particular interest in this technology due to the abundant supply of fresh/brackish water and salty water in close proximity.

The use of RED to produce electricity was discussed in the paper by Turek et al, Desalination 205 (2007) 67-74. RED gets its name from the fact that it is the reverse of conventional dialysis—instead of using electricity to desalinate sea water, energy is generated from the mixing of salty water with less salty water (typically sea water with fresh or brackish water). Djugolecki et al, J. of Membrane Science, 319 (2008) 214-222 discuss the most important membrane properties for RED.

In RED two types of membrane are used, namely one that is selectively permeable for positive ions and one that is selectively permeable for negative ions. Salt water isolated from fresh water between two such membranes will lose both positive ions and negative ions which flow through the membranes and into the fresh water. This charge separation produces a potential difference that can be utilized directly as electrical energy. The voltage obtained depends on factors such as the number of membranes in a stack, the difference in ion concentrations across the membranes, the internal resistance and the electrode properties.

U.S. Pat. No. 4,923,611 describes a process for preparing ion exchange membranes for conventional (as opposed to reverse) electrodialysis. The process was slow and energy intensive, requiring 16 hours to cure the membrane and temperatures of 80° C. Similarly the processes used in U.S. Pat. No. 4,587,269 and U.S. Pat. No. 5,203,982 took 17 hours at 80° C.

U.S. Pat. No. 6,737,111 describes polymeric membrane systems comprising a substrate having interstitial gaps spanned by gel-like membranes which may be crosslinked. The membrane systems are used in e.g. the electrophoretic separation of proteins.

In the biotechnology field, US patent publication No. 2004/0203149 describes composite materials comprising ionically charged, porous gels having an affinity for oppositely charged proteins. Typically a protein (e.g. BSA or lysozyme) is adsorbed onto the positively charged gel where it is washed. The protein is then desorbed from the gel by washing with a pH buffer.

In the fuel cell field, WO2005/111103 describes solid polymer electrolyte membranes for fuel cells. These were typically made using a slow and energy intensive process involving heating at 50° C. for 6 hours.

For all its potential benefits, a significant obstacle to the commercial use RED to generate energy is the high price of the necessary anionic and cationic membranes. Hitherto the price of the membranes has been a major factor in the final high kWh price. Turek et al concluded that prognosis for reducing membrane costs to the level necessary for making sea/fresh water RED energy generation commercially viable proposition was not good. Therefore membrane cost reduction represents a major hurdle to the commercial implementation of blue energy. Since the Turek et al article the cost of fossil fuels has increased dramatically. Therefore the need for an inexpensive and rapid process for producing robust membranes suitable for use in RED is greater than ever.

According to a first aspect of the present invention there is provided a process for manufacturing a composite membrane comprising a porous support and a polymeric separation layer having acidic or basic groups comprising the steps of:

(i) applying a composition to a porous support; and

(ii) curing the composition to form the polymeric separation layer thereon;

wherein the composition comprises the components (a) a compound having one ethylenically unsaturated group; and (b) a crosslinking agent having an acrylamide group; and wherein the curing is achieved by irradiating the composition for less than 30 seconds.

In order to be able to crosslink, the crosslinking agent will of course have two or more ethylenically unsaturated groups. Therefore when the crosslinking agent has only one acrylamide group it must have one or more ethylenically unsaturated groups other than an acrylamide group, e.g. an acrylate group. Preferably the crosslinking agent has two ethylenically unsaturated groups, one or both of which are acrylamide groups.

In preferred embodiments, the crosslinking agent has one or more of following features:
(I) at least two acrylamide groups;
(II) at least one acrylamide group comprising a tertiary nitrogen atom;
(III) two acrylamide groups each comprising a tertiary nitrogen atom;
(IV) a 5-, 6- or 7-membered ring comprising two nitrogen atoms each of which carries a —COC═CH₂ group.

Preferred crosslinking agents are of the Formula (I):

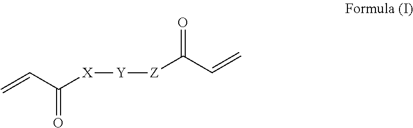

wherein:
Y is C₁₋₁₂-alkylene;
one of X and Z is NR₁ and the other is O or NR₂; and
R₁ and R₂ are each independently H or optionally substituted C₁₋₄-alkyl, or R₁ and R₂ together with the nitrogen atoms to which they are attached and together with Y form a 5-, 6- or 7-membered ring.

Preferably one of X and Z is NR₁ and the other is NR₂, wherein R₁ and R₂ are as hereinbefore defined.

The C₁₋₁₂ alkylene group represented by Y may take any form, for example it may consist of or comprise a branched and/or an unbranched chain. Y is preferably of the formula —CₙH₂ₙ— or —CₙH₍₂ₙ₋₂₎—.

Preferably R₁ and R₂ together with the nitrogen atoms to which they are attached and together with Y form a 5-, 6- or 7-membered ring. Preferred 5-, 6- or 7-membered rings are piperazinyl and homopiperazinyl rings.

As examples of suitable crosslinking agents there may be mentioned isophorone diacrylamide, N,N′-(1,2-dihydroxyethylene)bis-acrylamide, N,N-methylene-bis-acrylamide, 1,3,5-triacryloylhexahydro-1,3,5-triazine, 2,4,6-triallyloxy-1,3,5-triazine, N,N′-ethylenebis(acrylamide), bis(aminopropyl)methylamine diacrylamide, and especially 1,4-diacryoyl piperazine and 1,4-bis(acryloyl)homopiperazine, and combinations comprising two or more thereof. Preferably the crosslinking agent comprises 1,4-diacryoyl piperazine and/or 1,4-bis(acryloyl)homopiperazine.

Component (a) may be a single compound having one ethylenically unsaturated group or a combination of one or more of such compounds. Typically component (a) comprises:
(ai) a compound having one ethylenically unsaturated group and an acidic group, a basic group or a group that can be converted into an acidic or basic group; and optionally
(aii) a compound having one ethylenically unsaturated group and being free from acidic groups, basic groups and groups that can be converted into an acidic or basic group.

Preferably the acidic or basic groups present on the polymeric separation layer are derived from a copolymerisable substance included in the composition. For example, these acidic or basic groups may conveniently be obtained by selecting component (a) and/or (b) and/or a further component of the composition to have one or more groups selected from acidic groups, basic groups and groups which are convertible to acidic or basic groups.

When the compound has groups which are convertible to acidic or basic groups the process for preparing the membrane preferably comprises the step of converting such groups into acidic or basic groups, e.g. by a condensation or etherification reaction. Preferred condensation reactions are nucleophilic substitution reactions, for example the membrane may have a labile atom or group (e.g. a halide) which is reacted with a nucleophilic compound having a weakly acidic or basic group to eliminate a small molecule (e.g. hydrogen halide) and produce a membrane having the desired acidic or basic group. An example of a hydrolysis reaction is where the membrane carries side chains having ester groups which are hydrolysed to acidic groups.

Preferably the acidic groups are weakly acidic groups and the basic groups are weakly basic groups.

Preferred weakly acidic groups are carboxy groups and phosphato groups. These groups may be in the free acid or salt form, preferably in the free acid form. Preferred weakly basic groups are secondary amine and tertiary amine groups. Such secondary and tertiary amine groups can be in any form, for example they may be cyclic or acyclic. Cyclic secondary and tertiary amine groups are found in, for example, imidazoles, indazoles, indoles, triazoles, tetrazoles, pyrroles, pyrazines, pyrazoles, pyrrolidinones, triazines, pyridines, pyridinones, piperidines, piperazines, quinolines, oxazoles and oxadiazoles. The groups which are convertible to weakly acidic groups include hydrolysable ester groups.

The groups which are convertible to weakly basic groups include haloalkyl groups (e.g. chloromethyl, bromomethyl, 3-bromopropyl etc.). Haloalkyl groups may be reacted with amines to give weakly basic groups. Examples of compounds having groups which are convertible into weakly basic groups include methyl 2-(bromomethyl)acrylate, ethyl 2-(bromomethyl)acrylate, tert-butyl α-(bromomethyl)acrylate, isobornyl α-(bromomethyl)acrylate, 2-bromo ethyl acrylate, 2-chloroethyl acrylate, 3-bromopropyl acrylate, 3-chloropropyl acrylate, 2-hydroxy-3-chloropropyl acrylate and 2-chlorocyclohexyl acrylate.

Examples of suitable compounds which may be used as component (ai) there may be mentioned compounds comprising one ethylenically unsaturated group and a weakly acidic group, e.g. acrylic acid, beta carboxy ethyl acrylate, phosphonomethylated acrylamide, maleic acid, maleic acid anhydride, carboxy-n-propylacrylamide and (2-carboxyethyl)acrylamide; compounds comprising one ethylenically unsaturated group and a weakly basic group, e.g. N,N-dialkyl amino alkyl acrylates, e.g. dimethylaminoethyl acrylate and dimethylaminopropyl acrylate, and acrylamide compounds having weakly basic groups, e.g. N,N-dialkyl amino alkyl acrylamides, e.g. dimethylaminopropyl acrylamide and butylaminoethyl acrylate; and combinations thereof.

Examples of suitable compounds which may be used as component (aii) there may be mentioned 2-hydroxyethyl acrylate, polyethylene glycol monoacrylate, hydroxypropyl acrylate, polypropylene glycol monoacrylate, 2-methoxyethyl acrylate, 2-phenoxyethyl acrylate, and combinations comprising two or more thereof.

Curable compositions containing crosslinking agent(s) can sometimes be rather rigid and in some cases this can adversely affect the mechanical properties of the resultant membrane. However too much of ethylenically unsaturated compounds having only one ethylenically unsaturated group can lead to membranes with a very loose structure, adversely influencing the permselectivity. Also the efficiency of the curing can reduce when large amounts of curable compound(s) having only one ethylenically unsaturated group are used, increasing the time taken to complete curing and potentially requiring inconvenient conditions therefore. Bearing these factors in mind, the composition preferably comprises 10 to 98 wt % (e.g. 10 to 90 wt %), more preferably 30 to 96 wt % (e.g. 10 to 75 wt %), especially 40 to 95 wt % (e.g. 40 to 60 wt % or 70 to 90 wt %) of component (a) (including (ai) and (aii)). Especially preferably the composition comprises a high amount of component (ai) because this results in a high amount of charged groups and provides the membrane with a low electrical resistance.

The curable composition may of course contain further components in addition to those specifically mentioned above. For example the curable composition optionally comprises one or more further crosslinking agents and/or one or more further curable compounds.

Preferably the crosslinking agent has three or, more preferably, two acrylamide groups. In a particularly preferred embodiment the crosslinking agent has two acrylamide groups and component (a) has one acrylic group.

Component (a) is unable to crosslink because it has only one ethylenically unsaturated group (e.g. one H₂C═CHCO₂— or H₂C═CHCON< group). However it is able to react with other components present in the curable composition. Component (a) can provide the resultant membrane with a desirable degree of flexibility. When it carries an acidic or basic group (or a group convertible to such a group) it can also assists the membrane in distinguishing between ions of different charges by providing acidic or basic groups in the final composite membrane.

In one embodiment component (b) is preferably present in the curable composition in an amount of 20 to 90 wt %, more preferably 25 to 75 wt %, more especially 40 to 60 wt %.

In another embodiment, component (b) is preferably present in the curable composition in an amount of at least 4 wt %, more preferably 4 to 75 wt %, especially 5 to 60 wt %, more especially 10 to 40 wt %.

Generally component (b) provides strength to the membrane, while potentially reducing flexibility.

In one preferred embodiment the composition comprises at least 25 wt % of component (ai), more preferably 30 to 90 wt %, especially 30 to 80 wt % of component (ai).

In another preferred embodiment the composition comprises at least 25 wt % of component (ai), more preferably 30 to 98 wt %, especially 40 to 95 wt % of component (ai).

In a preferred embodiment the composition comprises 0 to 30 wt %, especially 0 to 20 wt % of component (aii).

In one preferred embodiment the weight ratio of component (ai) to component (b) is 0.3 to 3.0, more preferably 0.7 to 3, especially 1 to 2.

In another preferred embodiment the weight ratio of component (ai) to component (b) is 0.3 to 25, more preferably 0.7 to 25, especially 1 to 20, more especially 1 to 10.

The presence in the curable composition of component (a) having one (i.e. only one) ethylenically unsaturated group can impart a useful degree of flexibility to the membrane. Preferably component (a) has one (and only one) acrylic group.

Acrylic groups are of the formula H₂C═CH—C(═O)—. Preferred acrylic groups are acrylate (H₂C═CH—C(═O)—O—) and acrylamide (H₂C═CH—C(═O)—N<) groups of which the latter is more preferred because they can improve the resistance of the resultant membrane to hydrolysis.

It has been found that the use of acidic and basic curable compounds yields composite membranes which are particularly useful for reverse electrodialysis. Furthermore, such composite membranes may be prepared under mild process conditions (e.g. at ambient temperatures and without using extremes of pH).

Preferably the composition is substantially free from water (e.g. less than 5 wt % water, more preferably less than 1 wt % water, and especially no water) because low or no water content can improve permselectivity of the resultant membrane. Furthermore, low or no water saves the time and expense of drying the resultant membrane.

Preferably the composition is substantially free from organic solvents (e.g. less than 5 wt %, more preferably less than 1 wt % organic solvents) because this makes the manufacturing process more environmentally friendly.

The word ‘substantially’ is used because it is not possible to rule out the possibility of there being trace amounts of water or organic solvent in the components used to make the composition (e.g. because they are unlikely to be perfectly dry).

The use of acidic and basic curable compounds has the advantage of avoiding the need to include water in the composition and in turn this avoids or reduces the need for energy-intensive drying steps in the process.

When the composition is substantially free from water the components of the composition will typically be selected so that they are all liquid at the temperature at which they are applied to the support or such that any components which are not liquid at that temperature are soluble in the remainder of the composition. When the components are not liquid at ambient temperatures the process may further comprise the step of increasing the temperature of at least one of the components to above its melting temperature to achieve a liquid composition. Increasing the temperature has the additional advantage of lowering the viscosity of the composition, although this comes at the cost of increasing the energy required to manufacture the composite membrane. Preferably the curable composition is substantially free from methacrylic compounds (e.g. methacrylate and methacrylamide compounds), i.e. the composition comprises at most 10 wt % (more preferably at most 5%) of compounds which are free from acrylic groups and comprise one or more methacrylic groups.

The curable composition may comprise one or more than one crosslinking agent comprising at least two acrylamide groups. When the curable composition comprises more than one crosslinking agent comprising at least two acrylamide groups none, one or more than one of such crosslinking agents may have one or more groups selected from acidic groups, basic groups and groups which are convertible to acidic or basic groups.

The curable composition preferably comprises:
(ai) from 25 to 98 wt % (e.g. 25 to 80 wt %) of a compound comprising one ethylenically unsaturated group and an acidic group, a basic group or a group that can be converted into an acidic or basic group;
(aii) from 0 to 20 wt % of one compound comprising an ethylenically unsaturated group and being free from acidic groups, basic groups and groups that can be converted into a acidic or basic groups;
(b) from 4 to 75 wt % (e.g. 20 to 75 wt %) of a crosslinking agent having at least two acrylamide groups, each such group comprising a tertiary nitrogen atom; and
(c) from 0.1 to 15 wt % (e.g. 0.1 to 10 wt %) of photoinitiator.

Although the composition may comprise photoinitiator in amounts higher than 10 wt % in general we have not found that this provides better membranes.

The curable composition may contain other components, for example surfactants, viscosity enhancing agents, surface tension modifiers, biocides or other ingredients.

While this does not rule out the presence of other components in the composition (because it merely fixes the relative ratios of components (a), (b) and (c)), preferably the number of parts of (a)+(b)+(c) add up to 100. ((a) includes (ai)+(aii)).

Preferably the composition is substantially free from divinyl benzene.

Preferably the composition is substantially free from styrene.

Examples of suitable crosslinking agent(s) which may be include in the composition in addition to components (a) and (b) include poly(ethylene glycol) diacrylate, bisphenol A ethoxylate diacrylate, tricyclodecane dimethanol diacrylate, neopentyl glycol ethoxylate diacrylate, propanediol ethoxylate diacrylate, butanediol ethoxylate diacrylate, hexanediol diacrylate, hexanediol ethoxylate diacrylate, poly(ethylene glycol-co-propylene glycol) diacrylate, poly(ethylene glycol)-block-poly(propylene glycol)-block-poly(ethylene glycol) diacrylate, a diacrylate of a copolymer of polyethylene glycol and other building blocks e.g. polyamide, polycarbonate, polyester, polyimid, polysulfone, glycerol ethoxylate triacrylate, trimethylolpropane ethoxylate triacrylate, trimethylolpropane ethoxylate triacrylate, pentaerythrytol ethoxylate tetraacrylate, ditrimethylolpropane ethoxylate tetraacrylate, dipentaerythrytol ethoxylate hexaacrylate and combinations thereof.

Photo-initiators may be included in the curable composition and are usually required when curing uses UV or visible light radiation. Suitable photo-initiators are those known in the art such as radical type, cation type or anion type photo-initiators.

For acrylamides, bisacrylamides, acrylates, diacrylates, and higher-acrylates, type I photo-initiators are preferred. Examples of I photo-initiators are as described in WO 2007/018425, page 14, line 23 to page 15, line 26, which are incorporated herein by reference thereto. Especially preferred photoinitiators include alpha-hydroxyalkylphenones (e.g. 2-hydroxy-2-methyl-1-phenyl propan-1-one, 2-hydroxy-2-methyl-1-(4-tert-butyl-) phenylpropan-1-one, 2-hydroxy-[4′-(2-hydroxypropoxy)phenyl]-2-methylpropan-1-one, 2-hydroxy-1-[4-(2-hydroxyethoxy)phenyl]-2-methyl propan-1-one, 1-hydroxycyclohexylphenylketone and oligo[2-hydroxy-2-methyl-1-{4-(1-methylvinyl)phenyl}propanone]), alpha-aminoalkylphenones (e.g. 2-benzyl-2-(dimethylamino)-4′-morpholino-butyrophenone and 2-methyl-4′-(methylthio)-2-morpholinopropiophenone, alpha-sulfonylalkylphenones), acetophenones (e.g. 2,2-Dimethoxy-2-phenylacetophenone), and acylphosphine oxides (e.g. 2,4,6-trimethylbenzoyl-diphenylphosphine oxide, bis(2,6-dimethoxybenzoyl)-2,4,4 trimethylpentylphosphineoxide, ethyl-2,4,6-trimethyl benzoyl phenyl phosphinate and bis(2,4,6-trimethylbenzoyl)-phenylphosphine oxide). Also combinations of photoinitiators may be used.

Preferably the ratio of photo-initiator to the remainder of the curable components in the composition is between 0.0001 and 0.2 to 1, more preferably between 0.001 and 0.1 to 1, based on weight.

Curing (or ‘polymerisation’ as it is sometimes called) rates may be increased by including an amine synergist in the composition. Suitable amine synergists are e.g. free alkyl amines such as triethylamine, methyldiethanol amine, triethanol amine; aromatic amine such as 2-ethylhexyl-4-dimethylaminobenzoate, ethyl-4-dimethylaminobenzoate and also polymeric amines as polyallylamine and its derivatives. Curable amine synergists such as ethylenically unsaturated amines (e.g. acrylated amines) are preferable since their use will give less odour due to their ability to be incorporated into the membrane by curing and also because they may contain a weakly basic group which can be useful in the final membrane. The amount of amine synergists is preferably from 0.1-10 wt. % based on the weight of polymerizable compounds in the composition, more preferably from 0.3-3 wt. %.

Where desired, a surfactant or combination of surfactants may be included in the composition as a wetting agent or to adjust surface tension. Commercially available surfactants may be utilized, including radiation-curable surfactants. Surfactants suitable for use in the composition include non-ionic surfactants, ionic surfactants, amphoteric surfactants and combinations thereof.

Preferred surfactants are as described in WO 2007/018425, page 20, line 15 to page 22, line 6, which are incorporated herein by reference thereto. Fluorosurfactants are particularly preferred, especially Zonyl™ FSN (produced by E.I. Du Pont).

The permeability to ions can be influenced by the swellability of the membrane and by plasticization. By plasticization compounds penetrate the membrane and act as plasticizer. The degree of swelling can be controlled by the types and ratio of crosslinkable compounds, the extent of crosslinking (exposure dose, photo-initiator type and amount) and by other ingredients.

Other additives which may be included in the curable composition are acids, pH controllers, preservatives, viscosity modifiers, stabilisers, dispersing agents, inhibitors, antifoam agents, organic/inorganic salts, anionic, cationic, non-ionic and/or amphoteric surfactants and the like in accordance with the objects to be achieved.

Preferably the composition is free from compounds having tetralkyl-substituted quaternary ammonium groups.

Preferably the composition is free from compounds having sulpho groups.

The membrane is preferably an anion exchange membrane or a cation exchange membrane.

In one embodiment, the thickness of the composite membrane is preferably less than 200 μm, more preferably between 10 and 150 μm, most preferably between 20 and 100 μm.

In another embodiment, the thickness of the composite membrane is preferably less than 500 μm, more preferably between 10 and 300 μm, most preferably between 20 and 250 μm, especially between 20 and 100 μm or between 80 and 220 μm.

Preferably the composite membrane has an ion exchange capacity of at least 0.3 meq/g, more preferably of at least 0.5 meq/g, especially more than 1.0 meq/g, more especially more than 1.5 meq/g, based on the total dry weight of the composite membrane and the porous support and any porous strengthening material which remains in contact with the resultant membrane. Ion exchange capacity may be measured by titration.

Preferably the composite membrane has a charge density of at least 20 meq/m², more preferably at least 30 meq/m², especially at least 40 meq/m², based on the area of a dry membrane. Charge density may also be measured by titration.

Preferably the composite membrane has a power density of at least 0.4 W/m², more preferably at least 0.8 W/m², especially at least 1 W/m², more especially at least 1.3 W/m². The power density is enhanced by e.g. a low electrical resistance of the composite membrane.

Preferably the composite membrane has a permselectivity for small anions (e.g. Na⁺ or Cl⁻) of more than 75%, more preferably of more than 80%, especially more than 85% or even more than 90%. Preferably the membrane has a permselectivity for small cations (e.g. Na⁺) of more than 75%, more preferably of more than 80%, especially more than 85% or even more than 90%.

Preferably the composite membrane has an electrical resistance less than 10 ohm/cm², more preferably less than 5 ohm/cm², especially less than 3 ohm/cm².

Preferably the composite membrane exhibits a swelling in water of less than 50%, more preferably less than 20%, especially less than 10%. The degree of swelling can be controlled e.g. by selecting appropriate parameters in the curing step.

The water uptake of the composite membrane is preferably less than 50% based on weight of dry membrane, more preferably less than 40%, especially less than 30%.

Electrical resistance, permselectivity and % swelling in water may be measured by the methods described by Djugolecki et al, J. of Membrane Science, 319 (2008) on pages 217-218.

Typically the composite membrane is substantially non-porous e.g. the pores are smaller than the detection limit of a standard Scanning Electron Microscope (SEM). Thus using a Jeol JSM-6335F Field Emission SEM (applying an accelerating voltage of 2 kV, working distance 4 mm, aperture 4, sample coated with Pt with a thickness of 1.5 nm, magnification 100,000x, 3° tilted view) the average pore size is generally smaller than 5 nm.

According to a second aspect of the present invention there is provided a composite membrane comprising a porous support and a polymeric separation layer having acidic or basic groups obtained by a process comprising polymerisation of a composition comprising the components (a) a compound having one ethylenically unsaturated group; and (b) a crosslinking agent having an acrylamide group; and wherein the polymerisation has been achieved by irradiating the composition for less than 30 seconds.

The preferences for the composition used in the second aspect of the present invention are as described above in relation to the first aspect of the present invention.

The composite membrane according to the second aspect of the present invention is preferably obtainable or obtained by the process of the first aspect of the present invention.

Hitherto membranes have generally been made in slow and energy intensive processes, often having many stages. The present invention enables the manufacture of composite membranes in a simple process that may be run continuously for long periods of time to mass produce membranes relatively cheaply.

Steps (i) and (ii) are preferably performed without heating the composition, for example at a temperature between 10 and 60° C., more preferably at a temperature of 10 to 35° C. Irradiation of the composition will often increase its temperature a little. While higher temperatures may be used, e.g. to obtain a solution of the components or to lower the viscosity, these are not preferred because of the increased manufacturing costs.

Curing the composition in step (ii) typically forms the polymeric separation layer on (and in) the porous support, ensuring the polymeric separation layer is firmly affixed to the porous support.

Curing in step (ii) is preferably performed by radical polymerisation, preferably using electromagnetic radiation. The source of radiation may be any source which provides the wavelength and intensity of radiation necessary to cure the composition. When no photo-initiator is included in the composition, the composition can be cured by electron-beam exposure, e.g. using a dose of 20 to 100 kGy. Curing can also be achieved by plasma or corona exposure. Curing may be done in air or in an inert atmosphere such as N₂ or CO₂.

In one embodiment at least two of the compositions are coated (simultaneously or consecutively) onto the support. Thus coating step (i) may be performed more than once, either with or without curing step (ii) being performed between each coating step. As a consequence a composite membrane may be formed comprising at least one top layer and at least one bottom layer that is closer to the porous support than the top layer. In this embodiment the top layer and bottom layer, together with any intervening layers, constitute the polymeric separation layer (or membrane) and the porous support provides strength to the resultant composite membrane.

The process of the present invention may contain further steps if desired, for example washing and/or drying the composite membrane. When the composition comprises curable compounds having groups which are convertible to acidic or basic groups the process may further comprise the step of converting the groups which are convertible to acidic or basic groups into acidic or basic groups.

While it is possible to prepare the composite membrane on a batch basis using a stationary porous support, to gain full advantage of the invention it is much preferred to prepare the composite membrane on a continuous basis using a moving porous support. The porous support may be in the form of a roll which is unwound continuously or the porous support may rest on a continuously driven belt (or a combination of these methods). Using such techniques the composition can be applied to the porous support on a continuous basis or it can be applied on a large batch basis

The composition may be applied to the porous support by any suitable method, for example by curtain coating, blade coating, extrusion coating, air-knife coating, knife-over-roll coating, slide coating, nip roll coating, forward roll coating, reverse roll coating, dip coating, foulard coating, kiss coating, rod bar coating, spray coating or by a combination of methods. The coating of multiple layers can be done simultaneously or consecutively. For simultaneous coating of multiple layers, curtain coating, slide coating, slot die coating and extrusion coating are preferred.

The composition may be applied to the porous support in any order, for example layer of the composition may be coated directly onto the porous support or the porous support may be applied to a layer of the composition.

Thus in a preferred process the composition is applied continuously to a moving porous support, more preferably by means of a manufacturing unit comprising a curable composition application station, an irradiation source for curing the composition, a composite membrane collecting station and a means for moving the porous support from the composition application station to the irradiation source and to the composite membrane collecting station.

The composition application station may be located at an upstream position relative to the irradiation source and the irradiation source is located at a an upstream position relative to the composite membrane collecting station.

In order to produce a sufficiently flowable composition for application by a high speed coating machine, it is preferred that the composition has a viscosity below 4000 mPa·s when measured at 35° C., more preferably from 1 to 1000 mPa·s when measured at 35° C. Most preferably the viscosity of the composition is from 1 to 500 mPa·s when measured at 35° C. For coating methods such as slide bead coating the preferred viscosity is from 1 to 150 mPa·s, more preferably from 1 to 100 mPa·s, especially 2 to 100 mPa·s, when measured at 35° C.

With suitable coating techniques, the composition may be applied to a porous support moving at a speed of over 15 m/min, e.g. more than 20 m/min or even higher, such as 60 m/min, 120 m/min or up to e.g. 400 m/min, can be reached.

Before applying the composition to the surface of the porous support this support may be subjected to a corona discharge treatment, glow discharge treatment, flame treatment, ultraviolet light irradiation treatment or the like, e.g. for the purpose of improving its wettability and the adhesiveness, particularly where it is intended for the support to remain in the membrane in order to provide mechanical strength.

During curing the crosslinking agent(s) polymerise to form a polymer. The curing may be brought about by any suitable means, e.g. by irradiation and/or heating. If desired further curing may be applied subsequently to finish off, although generally this is not necessary.

The curing is preferably achieved by irradiating the composition with ultraviolet light or an electron beam.

Preferably curing of the composition begins within 3 minutes, more preferably within 60 seconds, especially within 15 seconds, more especially within 5 seconds and most preferably within 3 seconds, of the composition being applied to the porous support.

The curing is achieved by irradiating the composition for less than 30 seconds, preferably less than 10 seconds, especially less than 5 seconds, and more especially less than 2 seconds. In a continuous process the irradiation occurs continuously and the speed at which the curable composition moves through the beam of the irradiation is mainly what determines the time period of curing.

Preferably the curing uses blue-violet or ultraviolet light. Suitable wavelengths are for instance UV-A (400 to >320 nm), UV-B (320 to >280 nm), UV-C (280 to 200 nm) and blue-violet (445 to >400 nm, also called UV-V), provided the wavelength matches with the absorbing wavelength of any photo-initiator included in the composition.

Suitable sources of ultraviolet light are mercury arc lamps, carbon arc lamps, low pressure mercury lamps, medium pressure mercury lamps, high pressure mercury lamps, swirlflow plasma arc lamps, metal halide lamps, xenon lamps, tungsten lamps, halogen lamps, lasers and ultraviolet light emitting diodes. Particularly preferred are ultraviolet light emitting lamps of the medium or high pressure mercury vapour type. The energy output of the irradiation source is preferably from 20 to 1000 W/cm, preferably from 40 to 500 W/cm but may be higher or lower as long as the desired exposure dose can be realized. Exposure times can be chosen freely but preferably are short and are typically less than 2 seconds.

Preferably the composition is irradiated using a light source having an emission intensity of at least 19.7 W/cm (50 Watts/inch), more preferably at least 39.4 W/cm (100 Watts/inch), especially at least 78.7 W/cm (200 Watts/inch). The cm refers to the length of the light source. These intensities provide increasingly fast cure speeds, assisting with the rapid preparation of the composite membranes.

A typical example of a UV light source for curing is an H-bulb with an output of 236 W/cm (600 Watts/inch) as supplied by Fusion UV Systems. This light source has emission maxima around 220 nm, 255 nm, 300 nm, 310 nm, 365 nm, 405 nm, 435 nm, 550 nm and 580 nm. Alternatives are the V-bulb and the D-bulb which have different emission spectra with main emissions between 350 and 450 nm and above 400 nm respectively.

Preferably the irradiation matches with the absorption spectrum of the photoinitiator and the irradiation dose preferably is between 0.1 to 1.0 J/cm² in the UV-A region and/or 0.02 to 1.0 J/cm² in the UV-B region. The dose in the UV-A and UV-B region combined is preferably between 0.2 to 1.5 J/cm², more preferably between 0.4 and 0.9 J/cm². The dose may be measured using a radiometer, for example using a UV Power Puck™ High Energy UV Integrating Radiometer from Electronic Instrumentation & Technology, Inc., USA.

In one embodiment the light source irradiates the composition at a dose of 0.1 to 0.7 J/cm² in the UV-A region, 0.025 to 0.2 J/cm² in the UV-B region, 0.01 to 0.1 J/cm² in the UV-C region and 0.1 to 0.6 J/cm² in the UV-V region. The abovementioned D-bulb is particularly useful for providing these doses, e.g. at 100% power, with a 30 mm focus irradiating a composition moving at a speed of 30 m/minute.

To reach the desired dose of radiation to cure the composition at high coating speeds, step (ii) optionally comprises irradiation of the composition with more than one UV lamp. When two or more UV lamps are used the lamps may apply an equal dose of UV light or they may apply different doses of UV light. For instance, a first lamp may apply a higher or lower dose to the composition than a subsequent lamp. When more than one such UV lamp is used the lamps may emit the same or different wavelengths of light. The use of different wavelengths of light an be advantageous to achieve good curing properties, for example when one lamp emits light of a wavelength which achieves a good surface cure and another lamp emits light of a wavelength which achieves a good cure depth, in combination with suitable photoinitiators.

The porous support may be inorganic or organic, preferably organic. Preferred organic porous supports are polymeric. Examples of porous supports include, for example, a woven or non-woven synthetic fabric, e.g. polyethylene, polypropylene, polyacrylonitrile, polyvinyl chloride, polyester, polyamide, and copolymers thereof, or porous membranes based on e.g. polysulfone, polyethersulfone, polyphenylenesulfone, polyphenylenesulfide, polyimide, polyethermide, polyamide, polyamideimide, polyacrylonitrile, polycarbonate, polyacrylate, cellulose acetate, polypropylene, poly(4-methyl 1-pentene), polyinylidene fluoride, polytetrafluoroethylene, polyhexafluoropropylene, polychlorotrifluoroethylene, and copolymers thereof.

Commercially available non-woven porous supports are available commercially, e.g. from Freudenberg Filtration Technologies KG (Novatexx™ materials). Woven supports from, for example, Sefar AG.

Preferably the porous support has a hydrophilic character. Ion exchange membranes with weakly basic or acidic groups (e.g. tertiary amino, carboxyl and phosphato groups) can be made inexpensively by the present process and can exhibit good properties in terms of their permselectivity and conductivity.

The composite membranes of the invention are primarily intended for use in reverse electrodialysis, especially for the generation of blue energy. However it is envisaged that the membranes may have other uses, e.g. in electrodialysis, water purification and other applications. For example, the composite membranes of the present invention may be used in the devices described in U.S. Pat. No. 5,762,774, WO 2005/090242, US 20050103634 and US 20070175766. The composite membranes generally have good durability, with low tendency to deteriorate in use. They are also quite durable against higher temperatures and pH.

The porous support provides strength to the composite membrane and has a relatively large pore size compared to the separation layer. Thus the porous support preferably has an average pore size of 5 to 250 μm, more preferably 10 to 200 μm, especially 20 to 100 μm, as measured by a capillary flow porometer prior to application of the separation layer thereto. This can be compared to the average pore size of final composite membrane which is much smaller, preferably 0 to 4 μm, more preferably 0.0001 to 0.1 μm, especially 0.0001 to 0.01 μm, more especially 0.0002 to 0.001 μm.

In an especially preferred embodiment the composite membrane has an average pore size smaller than 0.5 nm. This ensures that the composite membrane has a low water permeability. Preferably the composite membrane has a water permeability lower than 1.10⁻⁷ m³/m²·s·kPa, more preferably lower than 1.10⁻⁸ m³/m²·s·kPa, most preferably lower than 5.10⁻⁹ m³/m²·s·kPa, especially lower than 1.10⁻⁹ m³/m²·s·kPa. The preferred water permeability depends to some extent on the intended use of the resultant composite membrane.

According to a third aspect of the present invention there is provided use of a composite membrane according to the second aspect of the present invention for the generation of electricity.

According to a fourth aspect of the present invention there is provided an electrodialysis or reverse electrodialysis unit comprising at least one anode, at least one cathode and one or more ion exchange membranes according to the second aspect of the present invention. Further the unit preferably comprises an inlet for providing a flow of relatively salty water along a first side of a membrane according to the present invention and an inlet for providing a less salty flow water along a second side of the membrane such that ions pass from the first side to the second side of the membrane. Preferably the one or more ion exchange membranes of the unit comprise a composite membrane according to the second aspect of the present invention having weakly acidic groups and a membrane according to the second aspect of the present invention having weakly basic groups. Preferably the unit further comprises one or more spacers to separate and prevent the membranes from touching each other.

In a preferred embodiment the unit comprises at least 10, more preferably at least 50, composite membranes according to the second aspect of the present invention. Alternatively, a continuous first composite membrane according to the present invention having acidic or basic groups may be folded in a concertina (or zigzag) manner and a second membrane having basic or acidic groups (i.e. of opposite charge to the first membrane) may be inserted between the folds to form a plurality of channels along which fluid may pass and having alternate anionic and cationic membranes as side walls. Preferably the second membrane is as defined in relation to the second aspect of the present invention.

In this specification (including its claims), the verb “comprise” and its conjugations is used in its non-limiting sense to mean that items following the word are included, but items not specifically mentioned are not excluded. In addition, reference to an element by the indefinite article “a” or “an” does not exclude the possibility that more than one of the elements is present, unless the context clearly requires that there be one and only one of the elements. For example “having one” means having one and only one (not including two or more). The indefinite article “a” or “an” thus usually means “at least one”.

The invention will now be illustrated with non-limiting examples where all parts and percentages are by weight unless specified otherwise.

In the examples the following properties were measured by the methods described below:

Permselectivity and electrical resistance aged were determined by storing the membrane at pH 9 and 60° C. for 5 days. After 5 days aging the film was stored into a 0.5 M NaCl solution for 12 hours after which the permselectivity and electrical resistance was measured by the methods described below.

Permselectivity and electrical resistance fresh were determined in essentially the same manner, except that instead of the 5 days ageing, the membranes were stored for 16 hours in a buffered solution (pH 4.3 for cationically charged membranes and pH 8 for anionically charged membranes).

Permselectivity was measured by using a static membrane potential measurement. Two cells are separated by the membrane under investigation. Prior to the measurement the composite membrane was equilibrated in a 0.5 M NaCl solution for at least 16 hours. Two streams having different NaCl concentrations were passed through cells on opposite sides of the membranes under investigation. One stream had a concentration of 0.1M NaCl (from Sigma Aldrich, min. 99.5% purity) and the other stream was 0.5 M NaCl. The flow rate was 0.74 litres/min. Two double junction Ag/AgCl reference electrodes (from Metrohm AG, Switzerland) were connected to capillary tubes that were inserted in each cell and were used to measure the potential difference over the membrane. The effective membrane area was 3.14 cm² and the temperature was 25° C.

When a steady state was reached, the membrane potential was measured (ΔVₘₑₐₛ)

The permselectivity (α(%)) of the composite membrane was calculated according the formula:

α(%)=ΔVₘₑₐₛ/ΔVₜₕₑₒᵣ*100%.

The theoretical membrane potential (ΔVₜₕₑₒᵣ) is the potential for a 100% permselective composite membrane as calculated using the Nernst equation.

Electrical resistance was measured by the method described by Djugolecki et al, J. of Membrane Science, 319 (2008) on page 217-218 with the following modifications:
the auxiliary membranes were from Tokuyama Soda, Japan;
the effective area of the membrane was 3.14 cm²;
the pumps used were Masterflex easyload II from Cole-Palmer;
the capillaries were filled with 3M KCl;
the reference electrodes were from Metrohm; and
cells 1, 2, 5 and 6 contained 0.5 M Na₂SO₄.

### Compounds Used in the Experiments

DMAPAA is N-(3-(dimethylamino)propyl)acrylamide, a curable compound having one acrylic group and a weakly basic group, obtained from Kohjin Chemicals, Japan.

1,4-diacryoyl piperazine (BAP) is a crosslinking agent having two acrylamide groups, obtained from Sigma-Aldrich.

2-carboxyethyl acrylate (CEA) is a curable compound having one acrylic group and a weakly acidic group, obtained from Sigma-Aldrich.

Irgacure™ 500 is a photoinitiator obtained from Ciba, Switzerland.

Irgacure™ 819DW is an aqueous photoinitiator dispersion from Ciba.

Irgacure™ 1870 is a photoinitiator obtained from Ciba. Irgacure™ is a trade mark of Ciba.

Additol™ HDMAP is 2-Hydroxy-2-methyl-1-phenyl propanone from Cytec.

Viledon™ Novatexx 2473 is a non woven polyethylene/polypropylene material of weight 30 g/m², thickness 0.12 mm having an air permeability of 2500 l/m²/s at 200 Pa from Freudenberg Filtration Technologies KG. Viledon™ is a trade mark of Freudenberg Filtration Technologies.

### Synthesis of Isophorone Diacrylamide

A mixture of triethylamine (10 cm³) and isophorone diamine (9.2 cm³) in dichloromethane (20 cm³) were added dropwise with stirring at 0° C. under a blanket of nitrogen to a solution of acryloyl chloride (8.3 cm³) in dichloromethane (20 cm³). The temperature was maintained below 10° C. throughout the entire addition. The dichloromethane was removed by rotary evaporation to give a solid. This solid was washed three times with 20 cm³ of water and the resultant product dried at 60° C. under vacuum. The structure of the product was confirmed by ¹H-NMR.

Synthesis of 1,4-bis(acryloyl)homopiperazine (BAHP)

This was prepared by essentially the same method as isophorone diacrylamide except that in place of isophorone diamine there was used homopiperazine (5.52 g) and the amounts of triethylamine and acryloyl chloride used were 14 cm³ and 8.5 cm³ respectively. Instead of washing with water, ethyl acetate (20 cm³) was added and the mixture was washed twice with NaCl solution (20 ml of a 10 mm % strength) then dried. The structure of the product was confirmed by ¹H-NMR.

### EXAMPLE 1

A composition (“C1”) was prepared by mixing the ingredients shown in Table 1:

TABLE 1

| Ingredient | Amount (wt %) |
|---|---|
| 1,4-diacryoyl piperazine | 40.75 |
| DMAPAA | 55.75 |
| Irgacure ™ 500 | 3.5 |

Step (i)—Applying the Composition to a Support

Composition C1 was coated onto an aluminium substrate to a wet thickness of 150 micrometers using a 150 μm bar coater to give a liquid film. Viledon™ Novatexx 2473 non-woven support was then laid on top of the liquid film. A slight excess of composition C1 was then applied on top of the Viledon™ Novatexx 2473 non-woven support and then levelled using a 4 μm bar coater to give a non-woven support which was fully saturated with composition C1.

Step (ii)—Curing

A composite membrane was prepared by curing the product of step (i) using a Light Hammer LH6 from Fusion UV Systems fitted with a D-bulb working at 100% intensity with a speed of 30 m/min (single pass) and a focus of 30 mm. The exposure time was about 0.5 seconds. This provided a UV-A dose of 0.40 J/cm², a UV-B dose of 0.14 J/cm², a UV-C dose of 0.016 J/cm² and a UV-V dose of 0.30 J/cm².

The resultant composite membrane having basic groups was removed from the substrate and stored for 16 hrs in 0.5M NaCl solution, buffered to pH 4.3

### Examples 2 to 13 and Comparative Examples 1 and 2

Further curable compositions (C2 to C13) and Comparative Examples 1 and 2 (CE1 and CE2) were prepared by mixing the ingredients shown in Table 2.

TABLE 2

| | C2 | C3 | C4 | C5 | C6 | C7 | C8 | C9 | C10 |
|---|---|---|---|---|---|---|---|---|---|
| Ingredient | wt % | wt % | wt % | wt % | wt % | wt % | wt % | wt % | wt % |
| DMAPAA | 53.8 | 49.8 | 74.7 | 79.1 | 51.1 | 44.5 | 23.0 | 79.8 | 95.8 |
| isophorone diacrylamide | 45.2 | | | | | | | | |
| 1,4-bis(acryloyl) homopiperazine | | 49.1 | | | | | 76.8 | 20.0 | 4.0 |
| 1,4-(bisacryloyl)piperazine | | | 24.1 | 19.8 | 47.5 | 44.1 | | | |
| Irgacure ™ 500 | | 1.1 | | | | | | | |
| Irgacure ™ 819 | 1.0 | | | | | | | | |
| Irgacure ™ 1870 | | | 1.2 | 1.1 | 1.3 | 11.3 | 0.2 | 0.2 | 0.2 |

| | C11 | C12 | C13 | CE1 | CE2 |
|---|---|---|---|---|---|
| Ingredient | wt % | wt % | wt % | wt % | wt % |
| DMAPAA | | | | 49.5 | 49.5 |
| isophorone diacrylamide | | | | | |
| 1,4-bis(acryloyl) homopiperazine | 49.9 | 25.9 | 9.9 | | |
| 1,4-(bisacryloyl)piperazine | | | | | |
| 2-carboxyethyl acrylate | 49.9 | 73.9 | 89.9 | | |
| 1,6-hexanediol diacrylate | | | | 49.5 | |
| Trimethylolpropane ethoxylated (1 EO/OH) | | | | | 49.5 |
| methyl ether diacrylate | | | | | |
| Irgacure ™ 500 | | | | 1.0 | 1.0 |
| Irgacure ™ 1870 | 0.2 | 0.2 | 0.2 | | |
| HDMAP | | | | | |
| water | | | | | |
| isopropanol | | | | | |

Steps (i) and (ii)—Application to a Support and Curing

Compositions C2 to C13, and CE1 and CE2 were applied to a porous support and cured exactly as described in Example 1. Examples 11 to 13 were stored for 16 hours in 0.5M NaCl solution, buffered to pH 8, prior to measurement.

### Results

The permselectivity and electrical resistance of the resultant composite membranes were measured using the methods described above. The results are as shown in Table 3:

TABLE 3

| | | | | Electrical | |
|---|---|---|---|---|---|
| | | Permselectivity | | resistance | |
| | | (α (%)) | | (ohm/cm²) | |
| Example | Composition | fresh | aged | fresh | aged |
| 1 | C1 | 95.1 | 87.3 | 5.6 | 3.0 |
| 2 | C2 | 86.3 | 87.5 | 3.1 | 3.0 |
| 3 | C3 | 91.1 | 85.0 | 2.5 | 2.0 |
| 4 | C4 | 93.5 | — | 1.5 | — |
| 5 | C5 | 92.1 | — | 1.1 | — |
| 6 | C6 | 89.1 | — | 5.0 | — |
| 7 | C7 | 93.4 | — | 5.1 | — |
| 8 | C8 | 94.7 | 95.6 | 17.8 | 12.8 |
| 9 | C9 | 93.9 | 95.3 | 1.3 | 1.0 |
| 10 | C10 | 81.0 | 80.6 | 0.5 | 0.6 |
| 11 | C11 | 93.2 | 94.5 | 30.7 | 23.7 |
| 12 | C12 | 93.7 | 95.1 | 11.6 | 10.0 |
| 13 | C13 | 90.3 | 94.0 | 5.1 | 3.5 |
| Comparative 1 | CE1 | 90.7 | 27.2 | 3.7 | 1.0 |
| Comparative 2 | CE2 | 62.7 | 24.5 | 1.7 | 0.7 |

1. A process for manufacturing a composite membrane comprising a porous support and a polymeric separation layer having acidic or basic groups comprising the steps of:
(i) applying a composition to a porous support; and
(ii) curing the composition to form the polymeric separation layer thereon;
wherein the composition comprises the components (a) a compound having one ethylenically unsaturated group; and (b) a crosslinking agent having an acrylamide group; and wherein the curing is achieved by irradiating the composition for less than 30 seconds.

2. The process according to claim 1 wherein curing is achieved by irradiating the composition with ultraviolet light or an electron beam for less than 10 seconds.

3. The process according to claim 1 wherein curing the composition begins within 3 minutes of the composition being applied to the porous support.

4. The process according to claim 1 wherein the composition comprises less than 5 wt % water.

5. The process according to claim 1 wherein the composition comprises less than 5 wt % organic solvent.

6. The process according to claim 1 wherein the composition comprises less than 5 wt % water and less than 5 wt % organic solvent.

7. The process according to claim 1 wherein the composition is irradiated using a light source having an emission intensity of at least 39.4 W/cm.

8. The process according to claim 1 wherein component (b) is present in the curable composition in an amount of 10 to 40 wt % at least 4 wt %.

9. (canceled)

10. The process according to claim 1 wherein the composition is applied continuously to the moving porous support by means of a manufacturing unit comprising a curable composition application station, an irradiation source for curing the composition, a composite membrane collecting station and a means for moving the porous support from the composition application station to the irradiation source and to the composite membrane collecting station.

11. The process according to claim 1 wherein the crosslinking agent has at least two acrylamide groups.

12. (canceled)

13. (canceled)

14. (canceled)

15. (canceled)

16. (canceled)

17. (canceled)

18. The process according to claim 1 wherein the composition further comprises a photoinitiator.

19. The process according to claim 1 wherein the composition comprises:
(ai) from 25 to 98 wt % of a compound comprising an ethylenically unsaturated group and an acidic group, a basic group or a group that can be converted into an acidic or basic group;
(aii) from 0 to 20 wt % of a compound comprising an ethylenically unsaturated group and being free from acidic groups, basic groups and groups that can be converted into a acidic or basic groups;
(b) from 4 to 75 wt % of a crosslinking agent having at least two acrylamide groups, each such group comprising a tertiary nitrogen atom; and
(c) from 0.1 to 15 wt % of photoinitiator.

20. (canceled)

21. A composite membrane comprising a porous support and a polymeric separation layer having acidic or basic groups obtained by a process comprising polymerisation of a composition comprising the components (a) a compound having one ethylenically unsaturated group; and (b) a crosslinking agent having an acrylamide group; and wherein the polymerisation has been achieved by irradiating the composition with ultraviolet light or an electron beam for less than 10 seconds.

22. (canceled)

23. An electrodialysis or reverse electrodialysis unit comprising at least one anode, at least one cathode and one or more ion exchange membrane according to claim 20.

24. The process according to claim 2 wherein the composition comprises less than 5 wt % water and less than 5 wt % organic solvent.

25. The process according to claim 1 wherein component (b) is present in the curable composition in an amount of 40 to 60 wt %.

26. The process according to claim 2 wherein component (b) is present in the curable composition in an amount of 10 to 40 wt %.

27. The process according to claim 2 wherein component (b) is present in the curable composition in an amount of 40 to 60 wt %.

28. The process according to claim 25 wherein the composition is applied continuously to the moving porous support by means of a manufacturing unit comprising a curable composition application station, an irradiation source for curing the composition, a composite membrane collecting station and a means for moving the porous support from the composition application station to the irradiation source and to the composite membrane collecting station.

29. The process according to claim 26 wherein the composition is applied continuously to the moving porous support by means of a manufacturing unit comprising a curable composition application station, an irradiation source for curing the composition, a composite membrane collecting station and a means for moving the porous support from the composition application station to the irradiation source and to the composite membrane collecting station.

30. The process according to claim 1 wherein the curing is achieved by irradiating the composition for less than 5 seconds.
